(19) United States
(12) Patent Application Publication
(10) Pub. No.: US 2002/0178373 A1
(43) Pub. Date: Nov. 28, 2002

(54) Computer virus rejection system and method

(76) Inventors: Randice-Lisa Altschul, Cliffside Park, NJ (US); Lee S. Volpe, Mount Laurel, NJ (US)

Correspondence Address: Arthur Jacob, 25 East Salem Street, P.O. Box 686, Hackensack, NJ, 07602, US

(21) Appl. No.: 09/835,700

(22) Filed: Apr. 16, 2001

(51) Int. Cl. H04L 9/00

(52) U.S. Cl. 713/200

(57) ABSTRACT

Access to the operating system of a computer by a computer virus carried by incoming message data is precluded by directing the incoming message data to a containment field device separate from and parallel to the operating system so as to quarantine the message data from the operating system, then diagnosing the quarantined message data for aberrant data indicative of the presence of a computer virus and, should aberrant data be detected, denying access to the operating system, thereby precluding access by the computer virus to the operating system. The malignant message data then is rejected and may be traced and then returned to the source of the message.

The present invention relates generally to communication carried out through the use of computers connected to a global computer network, such as the world wide web, and pertains, more specifically, to protecting the programs and data in a computer against the destructive effects of a computer virus carried by an incoming message directed to the computer by precluding access to the operating system of the computer by the computer virus.

The rapid proliferation of computers connected to a global computer network, commonly referred to as the world wide web, or the INTERNET, and the use of these computers for communication purposes, especially in the form of electronic mail, or e-mail, has spawned a potentially dangerous and illegal practice of introducing a spurious program, dubbed a computer virus, into message data directed to a computer so as to invade the operating system of the computer with a virus designed to damage or destroy legitimate data in the invaded computer. As a result, anti-virus programs have been developed to combat these spurious programs; however, these anti-virus programs can be relatively elaborate and expensive, and usually function to find and deal with the offending virus only after the operating system of the computer has already been invaded by the destructive virus.

The present invention provides a system and method for combatting a computer virus before the virus can enter the operating system of a computer. As such, the present invention attains several objects and advantages, some of which are summarized as follows: Precludes entry of a computer virus into the operating system of a computer for increased safety against potential damage resulting from access to the operating system by the virus through the admission of incoming message data; enables detection of a computer virus carried by an incoming message prior to admitting the message to the operating system of the computer, and rejection of the message should the message be deemed to carry an offending virus; assures increased protection of programs and data in a computer connected to the world wide web by rejecting any incoming message carrying a destructive computer virus; allows a user several options in dealing with malignant messages, as well as benign messages, directed to the user's computer, with added ease and efficiency; avoids costly reprogramming and recreation of data which otherwise might be required as a result of an invasion by a computer virus; deters a potential originator of a computer virus from creating and attempting to spread a destructive virus; provides a relatively inexpensive and highly effective system and method for combatting a computer virus, rendering the benefits of the system and method economically available to a greater number and a wider variety of end users.

The above objects and advantages, as well as further objects and advantages, are attained by the present invention which may be described briefly as a computer virus rejection system for use in connection with a computer having an operating system, for precluding access to the operating system of the computer by a computer virus carried with an incoming message directed to the computer, the incoming message including incoming message data, the system comprising: a containment field device separate from and parallel to the operating system of the computer; a containment operator device for treating incoming message data so as to direct the incoming message data to the containment field device and maintain the incoming message data quarantined from the operating system; a scanner for scanning the quarantined message data; and a comparator for diagnosing the quarantined message data scanned by the scanner to detect any aberrant data contained within the quarantined message data, for rejecting any quarantined message data within which aberrant data is detected so as to preclude entry of the aberrant data into the operating system of the computer, and for admitting into the operating system of the computer any quarantined message data determined not to contain aberrant data.

Additionally, the present invention can include a comparator for condensing the message data admitted into the operating system in order to reduce the amount of data needed to store essential information carried by the incoming message.

Further, the present invention includes a method for use in connection with a computer having an operating system, for precluding access to the operating system of the computer by a computer virus carried with incoming message data directed to the computer, the method comprising: treating incoming message data so as to direct the incoming message data to a containment field device and maintain the incoming message data quarantined from the operating system of the computer; diagnosing the quarantined message data to detect any aberrant data contained within the quarantined message data; and rejecting any quarantined message data within which aberrant data is detected so as to preclude entry of the aberrant data into the operating system of the computer.

The invention will be understood more fully, while still further objects and advantages will become apparent, in the following detailed description of preferred embodiments of the invention illustrated in the accompanying drawing, in which:

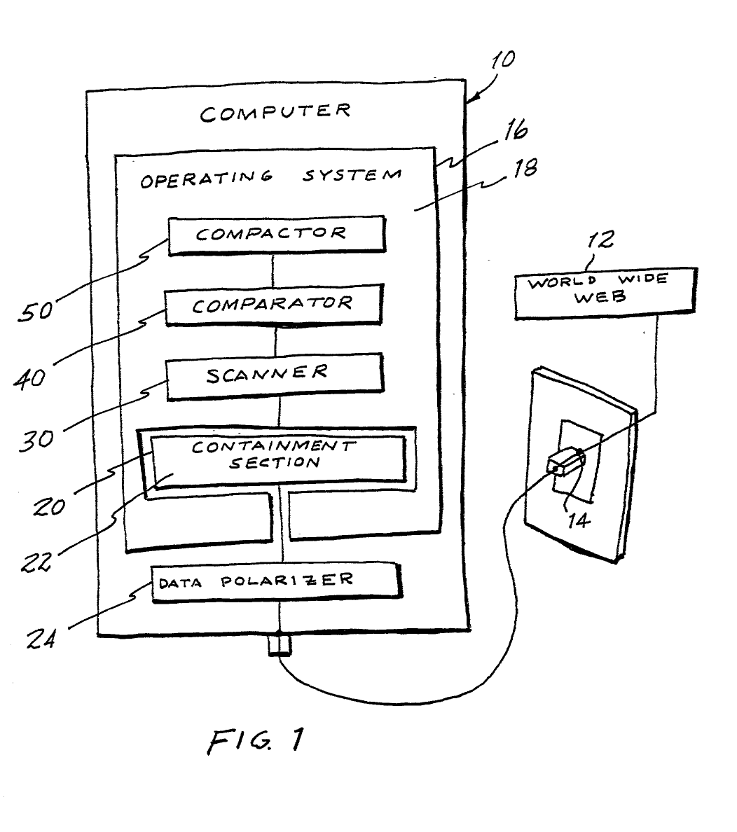

FIG. 1 is a schematic diagram illustrating a system and method of the present invention;

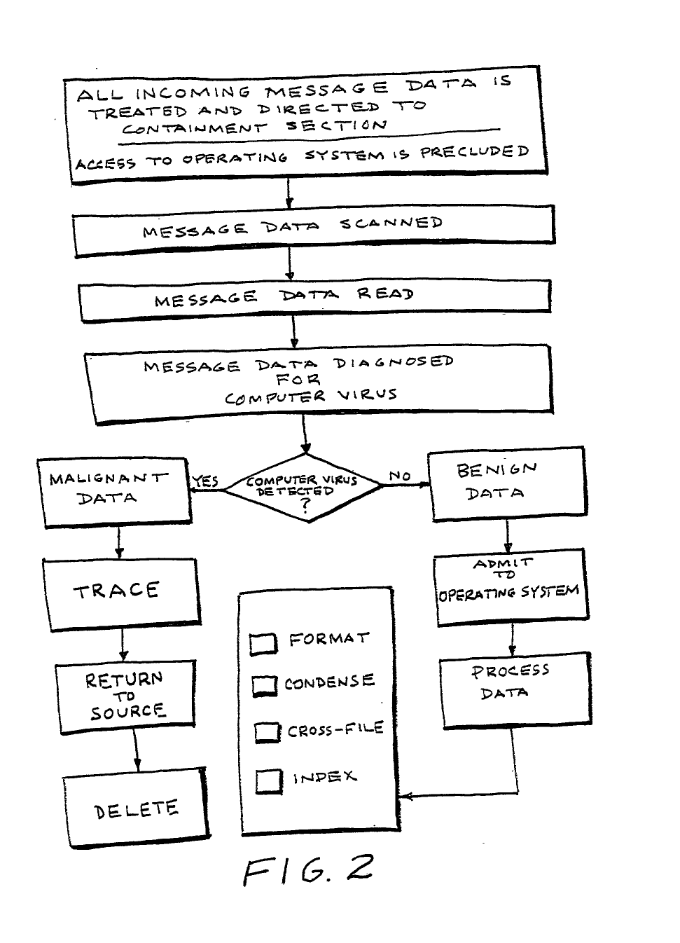

FIG. 2 is a flow chart diagram demonstrating the operation of the system and method;

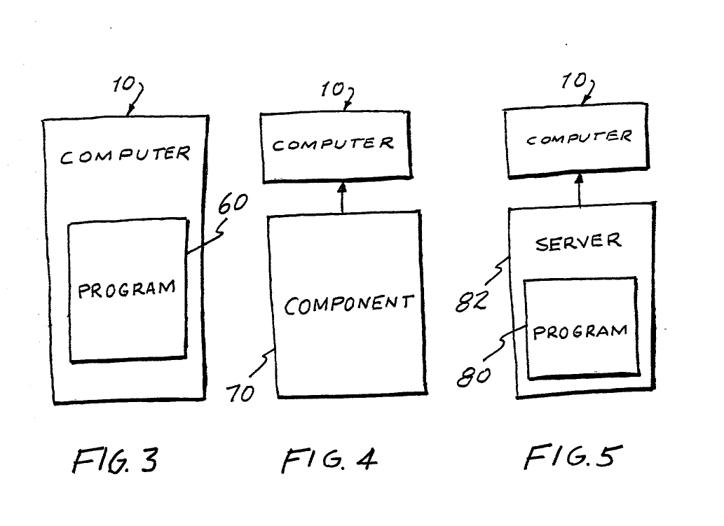

FIG. 3 is a block diagram illustrating an arrangement in a system constructed in accordance with the present invention;

FIG. 4 is a block diagram illustrating an alternate arrangement; and

FIG. 5 is a block diagram illustrating another alternate arrangement.

Referring now to the drawing, and especially to FIGS. 1 and 2 thereof, a computer 10 is seen to be connected to the world wide web 12 at a connection 14. Computer 10 includes an operating system 16 configured for accepting data of a given polarity. Thus, in the illustrated embodiment, the operating system 16 includes a positive field 18 for accepting data having a positive polarity. A containment field device in the form of a containment section 20 is located within the computer 10 and provides a field 22 which is separate from and parallel to the positive field 18 of operating system 16, and which has a negative polarity.

A containment operator device in the form of a data polarizer 24 is interposed between connection 14 and containment section 20 for directing incoming message data to the containment section 20. The incoming message data is treated by the data polarizer 24 by polarizing the incoming message data to provide the incoming message data with a negative polarity, opposite to the positive polarity of field 18 of the operating system 16. In this manner, the incoming message data is quarantined so as to isolate the incoming message data from the operating system 16 and thereby preclude entry of the incoming message data into the operating system 16.

A scanner 30 in the computer 10 then scans and reads the message data contained and quarantined within the containment section 20 and a comparator 40 then diagnoses the scanned message data by comparing and analyzing the message data in order to determine whether or not any aberrant data is present within the quarantined message data, which aberrant data would be indicative of the presence of a malignant computer virus in the quarantined message data. Should the diagnosis detect aberrant data in the quarantined message data, the message data is deemed to carry a destructive computer virus and is rejected; that is, the malignant message data is not admitted to the operating system 16. The malignant message data then preferably is deleted so as not to present a threat to the programs and data stored in the computer 10. Alternately, the malignant message data is analyzed further to determine the source from which the message emanated, and then the message data may be traced and optionally returned to the message source.

Should there be no aberrant data detected in the quarantined message data, the message data is deemed to be benign, that is, the message data is found to be free of any harmful computer virus, and the message data is admitted to the operating system 16 for further processing. In one embodiment of the present invention, optional further processing of the message data is carried out in a compactor 50 wherein the message data is selectively re-formatted or condensed to delete superfluous information, such as computer routing and like data, in order to reduce the amount of data needed to store the information in the message. Additionally, the message data can be cross-filed and indexed by the compactor 50 in terms of date, time, to, from or other general information not essential to the message, in order to enable ease of location and retrieval of the information in the message.

Turning now to FIG. 3, in a first arrangement, the containment field device is in the form of a computer program 60 installed within the computer 10 itself. In an alternate arrangement illustrated in FIG. 4, the containment field device is in the form of a free-standing separate component 70 placed outside the computer 10, and connected to the computer 10. In another alternate arrangement illustrated in FIG. 5, the containment field device is in the form of a computer program 80 installed in a separate remote server 82 connected to the computer 10. In any one of these arrangements, the containment field remains separate from and parallel to the operating system 16 of the computer 10 so as to preclude entry of any computer virus-infected message data into the operating system 14 of the computer 10.

It will be seen that the present invention attains all of the objects and advantages summarized above, namely: Precludes entry of a computer virus into the operating system of a computer for increased safety against potential damage resulting from access to the operating system by the virus through the admission of incoming message data; enables detection of a computer virus carried by an incoming message prior to admitting the message to the operating system of the computer, and rejection of the message should the message be deemed to carry an offending virus; assures increased protection of programs and data in a computer connected to the world wide web by rejecting any incoming message carrying a destructive computer virus; allows a user several options in dealing with malignant messages, as well as benign messages, directed to the user's computer, with added ease and efficiency; avoids costly reprogramming and recreation of data which otherwise might be required as a result of an invasion by a computer virus; deters a potential originator of a computer virus from creating and attempting to spread a destructive virus; provides a relatively inexpensive and highly effective system and method for combatting a computer virus, rendering the benefits of the system and method economically available to a greater number and a wider variety of end users.

It is to be understood that the above detailed description of preferred embodiments of the invention is provided by way of example only. Various details of design, construction and procedure may be modified without departing from the true spirit and scope of the invention, as set forth in the appended claims.

The embodiments of the invention in which an exclusive property or privilege is claimed are defined as follows:

1. A computer virus rejection system for use in connection with a computer having an operating system, for precluding access to the operating system of the computer by a computer virus carried with an incoming message directed to the computer, the incoming message including incoming message data, the system comprising:
a containment field device separate from and parallel to the operating system of the computer;
a containment operator device for treating incoming message data so as to direct the incoming message data to the containment field device and maintain the incoming message data quarantined from the operating system;
a scanner for scanning the quarantined message data; and
a comparator for diagnosing the quarantined message data scanned by the scanner to detect any aberrant data contained within the quarantined message data, for rejecting any quarantined message data within which aberrant data is detected so as to preclude entry of the aberrant data into the operating system of the computer, and for admitting into the operating system of the computer any quarantined message data determined not to contain aberrant data.

2. The computer virus rejection system of claim 1 including a compactor for condensing the message data admitted into the operating system in order to reduce the amount of data needed to store essential information carried by the incoming message.

3. The computer virus rejection system of claim 1 wherein the operating system of the computer is configured for accepting data of a given polarity, the containment field device is configured for accepting data of a polarity opposite to the given polarity, and the containment operator device polarizes the incoming message data so as to provide the incoming message data with a polarity opposite to the given polarity.

4. The computer virus rejection system of claim 3 wherein the containment field device is located within the computer.

5. The computer virus rejection system of claim 3 wherein the containment field device comprises a separate component outside the computer.

6. The computer virus rejection system of claim 3 wherein the containment field device is located in a separate server associated with the computer.

7. The computer virus rejection system of claim 3 including a compactor for condensing the message data admitted into the operating system in order to reduce the amount of data needed to store essential information carried by the incoming message.

8. A method for use in connection with a computer having an operating system, for precluding access to the operating system of the computer by a computer virus carried with incoming message data directed to the computer, the method comprising:
treating incoming message data so as to direct the incoming message data to a containment field device and maintain the incoming message data quarantined from the operating system of the computer;
diagnosing the quarantined message data to detect any aberrant data contained within the quarantined message data; and
rejecting any quarantined message data within which aberrant data is detected so as to preclude entry of the aberrant data into the operating system of the computer.

9. The method of claim 8 including admitting into the operating system of the computer any quarantined message data determined not to contain aberrant data.

10. The method of claim 9 including condensing the message data admitted into the operating system in order to reduce the amount of data needed to store essential information carried by the incoming message.

11. The method of claim 8 wherein the operating system of the computer is configured for accepting data of a given polarity, the containment field device is configured for accepting data of a polarity opposite to the given polarity, and the step of treating the incoming message data includes polarizing the incoming message data so as to provide the incoming message data with a polarity opposite to the given polarity.

12. The method of claim 11 including subsequently providing the quarantined message data determined not to contain aberrant data with a polarity the same as the given polarity, and then admitting into the operating system of the computer any quarantined message data determined not to contain aberrant data.

13. The method of claim 8 including subsequently deleting the quarantined message data within which aberrant data is detected.

14. The method of claim 8 wherein the incoming message emanates from a message source and the method includes tracing the message data to the message source.

15. The method of claim 8 wherein the incoming message emanates from a message source and the method includes subsequently returning to the message source the quarantined message data within which aberrant data is detected.
